(19) United States
(12) Patent Application Publication
(10) Pub. No.: US 2014/0102685 A1
(43) Pub. Date: Apr. 17, 2014

(54) DEVICE FOR COOLING A COMPONENT OF AN ELECTRICAL MACHINE USING COOLING COILS

(71) Applicant: Siemens Aktiegesellschaft, Munchen (DE)

(72) Inventors: Michael-Adolf Gadelmeier, Augsburg (DE); Heinrich Lefrank, Scwabach (DE)

(73) Assignee: Siemens Aktiengesellschaft, Munchen (DE)

(21) Appl. No.: 14/051,974

(22) Filed: Oct. 11, 2013

(30) Foreign Application Priority Data
Oct. 12, 2012 (EP) 12188383

(51) Int. Cl. H02K 1/20

(52) U.S. Cl. CPC H02K 1/20
USPC 165/177

(57) ABSTRACT

A device for cooling a component includes first and second cooling cons for circulation of a coolant. The first and second cooling coils have serpentine sections and distance sections connecting neighboring ones of the serpentine sections to each other for cooling individual non-neighboring component areas. Each distance section is configured to bridge a component area which is cooled by a one of the serpentine-shaped sections of the first and second cooling coils.

### CROSS-REFERENCES TO RELATED APPLICATIONS

This application claims the priority of European Patent Application, Serial No. 121 88 383, filed Dec. 12, 2012, pursuant to 35 U.S.C. 119(a)-(d), the disclosure of which is incorporated herein by reference in its entirety as if fully set forth herein.

### BACKGROUND OF THE INVENTION

The present invention relates to the field of cooling a component of an electrical machine using a number of cooling coils

The following discussion of related art is provided to assist the reader in understanding the advantages of the invention, and is not to be construed as an admission that this related art is prior art to this invention.

Windings through which current flows in laminated cores, such as are used in dynamoelectric machines for example, often heat up the laminated core into which they are inserted, through eddy currents for example, to a significant extent. Therefore sufficient cooling is necessary, especially for electrical machines in use over the long term, in order to avoid overheating of individual components. An especially efficient cooling is conveying a cooling fluid, such as water or oil for example, through pipes which are in thermal contact with the laminated core. The use of oil as a coolant is often preferred to the use of water for cooling electrical machines, since oil does not conduct the electrical current and generally has a higher boiling point than water. However it should be noted that silicon hoses are not suitable for carrying coolants containing oil or a few other aqueous solutions.

It would therefore be desirable and advantageous to obviate other prior art shortcomings and to achieve a cooling of a component that is as even as possible, for example of a large-surface-area laminated core, and at the same time to use oil as a coolant, while being simple in structure and reliable in operation.

### SUMMARY OF THE INVENTION

According to one aspect of the present invention, a device for cooling a component, e.g. a laminated core of a dynamoelectric machine, includes first and second cooling coils, the first and second cooling coils having serpentine sections and distance sections connecting neighboring ones of the serpentine sections to each other for cooling individual non-neighboring component areas, each distance section being configured to bridge a component area which is cooled by a one of the serpentine-shaped sections of the first and second cooling coils.

According to another advantageous feature of the present invention, each of the first and second cooling coils can have at least two serpentine sections interconnected by a distance section, the distance section of the first cooling coil being configured to bridge a component area which is cooled by the serpentine-shaped sections of the second cooling coil, and the distance section of the second cooling coil being configured to bridge a component area which is cooled by the serpentine-shaped sections of the first cooling coil.

The division of the component into areas, which are cooled by different sections of a cooling coil, has the advantage of an especially even cooling. Were only one cooling coil to cool the entire component, because of the heating-up of the coolant during its passage through the cooling coil, the cooling of those areas which have those sections of the cooling coil in which the coolant already has a high temperature would be reduced. When cooling coils positioned next to one another are used, which are supplied with a coolant in parallel and only cool neighboring areas in each case, although the evenness of the cooling would be improved—at the same time however the number of connections would increase. In addition the necessity might arise for connecting hoses within the electrical machine, which restricts the choice of coolant. Furthermore leakage points in the coolant circuit are often localized at connections and hose couplings. Therefore the number of connections, especially within the housing of an electrical machine, should be as small as possible. Because of restricted space within or outside an electrical machine only a restricted number of feed lines and drain lines to the cooling coil is able to be realized. Through the device described both the even cooling of the component is improved and equally also the number of connections is significantly reduced. In addition it is possible to dispense with connecting hoses within the electrical machine and thus this device is also especially suitable for the use of oil as the coolant.

According to another aspect of the present invention, a method for cooling a component, e.g. a laminated core of a dynamoelectric machine, includes form-fittingly fitting cooling pipes into prefabricated recesses of the component to produce first and second cooling coils having serpentine sections and distance sections connecting neighboring ones of the serpentine sections to each other for cooling individual non-neighboring component areas, each distance section being configured to bridge a component area which is cooled by a one of the serpentine-shaped sections of the first and second cooling coils.

A method according to the present invention, combines the advantage of an efficient cooling of a component with a cost-effective method of manufacturing such a device. The groove provided for the cooling pipes can be created in a simple manner during the punching process. The form-fit connection of the laminated core and the cooling pipe can be made most easily by a pressing process. In this case the shape of the cooling pipes is adapted to the recess in the laminated core. In the case of another component in which this recess is not advantageous, the cooling coil can also be connected to the surface with the aid of a thermal bridge.

According to another advantageous feature of the present invention, the first cooling coil may have only a single serpentine-shaped section configured to cool a component area and the second cooling coil may have at least two serpentine-shaped sections configured to cool component areas which are not cooled by the first cooling coil. This configuration is especially provided for use in an electrical machine, in which the component to be cooled can be advantageously divided into two, not necessarily contiguous areas and the central area is cooled by a cooling coil and the other area is cooled by a further cooling coil, which bridges the area of the one cooling coil by a distance section. This simplified device can also be used if for example only one specific area is to be cooled separately and another area only has to be cooled to a lesser extent. In this last case in particular, this design ensures an especially even temperature of the component.

According to another advantageous feature of the present invention, the first and second cooling coils may each be made of a piece of pipe. The production of the cooling coils from one individual pipe contributes to avoiding leakage points. In addition the number of connection couplings is reduced by comparison with cooling coils with a number of components.

According to another advantageous feature of the present invention, coolant may flow through the first cooling coil in one direction of flow, and coolant may flow through the second cooling coil in a direction of flow which is different than the direction of flow through the first cooling coil. This further improves cooling. The fact that the coolant flows through the individual cooling coils in different directions ensures that both sides of the component—and also the individual areas—are cooled evenly, since the areas in which the coolant already has a higher temperature are surrounded by areas in which the coolant, after moving only a short distance through the cooling coil, has only a slightly higher temperature than after an almost complete passage through the cooling coil.

According to another advantageous feature of the present invention, neighboring component areas cooled by serpentine-shaped sections of the first and second cooling coils, respectively, can overlap one another. The option of overlapping can be provided at one or more levels. In the first case for example the cooling coils describe a slight zigzag pattern, wherein the turns run above one another in some cases. In the second case the cooling coils run at two, advantageously parallel, levels, which then partly overlap in the projection. This is especially advantageous for components with heavily localized heat development, if the construction of the component and/or of the electrical machine allows this.

According to another advantageous feature of the present invention, each serpentine-shaped section of the first and second cooling coils can have parallel cooling pipes defined by a diameter and spaced from one another by a spacing, with diameter and spacing being variable. Often individual areas of components are affected more greatly by the heating-up occurring than other areas. In more strongly heated areas a reduction of the spacing between the pipes of the cooling coil provided for cooling can contribute to better cooling in some areas. Furthermore, as a result of its construction, areas can occur in a component in which—for example because of the necessary stability—the cooling coils with a smaller diameter are used for building in. The thermal contact surface between components and the coolant is then able to be equalized by a higher coolant flow speed.

According to another advantageous feature of the present invention, one of the neighboring serpentine-shaped sections may have six turns and, following the distance section, the other one of the neighboring serpentine-shaped section may have five or fewer turns. This configuration is especially useful in electric rotating machines, since the ends of the cooling coils are then located on different sides of the component when an uneven number of serpentine-shaped sections with five turns is used. Thus the connections to the feed lines and drain lines of the coolant are bundled and can advantageously be connected to the cooling system. In addition the decreasing number of turns takes account of the fact that as the distance through which the coolant passes increases, its temperature rises.

The rise in temperature of the coolant reduces the efficiency of the cooling, consequently the area to be cooled is to be reduced as well as cooled if necessary by a serpentine-shaped section of a further cooling coil which has coolant passing through it at a temperature that is still low. A combination of two cooling coils, one of which has six turns and one of which five turns, has proven to be particularly advantageous. Depending on the size of the component to the cooled one or more of these combinations can be used, whereby these preferably are able to have a coolant flowing through them in parallel. In production this produces the advantage of different sizes of components, for example different circumferences of torque motors, being able to be equipped with one type of cooling coil.

A typical application is a laminated core of an electric machine which is equipped with a device for cooling in accordance with the present invention. As a carrier of windings, a laminated core is for example continuously heated up during its operation by eddy currents which occur. A device in accordance with the present invention is especially well suited to keeping overheating in check, since the cooling coils can be simply pressed into grooves which were previously made in the laminations by a punching process and are thus in good thermal contact with the component. At the same time cooling is provided in an even manner by the division of the component into individually cooled areas.

A further field of application of a device in accordance with the present invention can be a stator or rotor of an electric machine, which, as described above, often has to be cooled to a significant extent because of friction or electrical effects in order to guarantee smooth operation of the electric machine.

A device in accordance with the present invention for cooling can be especially suitable for use in a dynamoelectric machine, especially a torque motor or a linear motor having a rotor and/or a stator. An electric motor or a generator, especially designed as a torque motor, is characterized by laminated cores having a plurality of windings. If these motors provide a high power capability a cooling of these laminated cores both in the stator but also in the rotor is provided to a great extent so that there is no risk of thermally-induced power losses or failures of the motor. Even cooling demands special attention here, which is why this device, as already stated, is especially well suited.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic and simplified illustration of a possible course of cooling loops in a component;

FIG. 2 is a perspective illustration of a component cooled by only two cooling coils; and

FIG. 3 is a schematic and simplified illustration of a configuration with two cooling coils for use in a torque motor.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

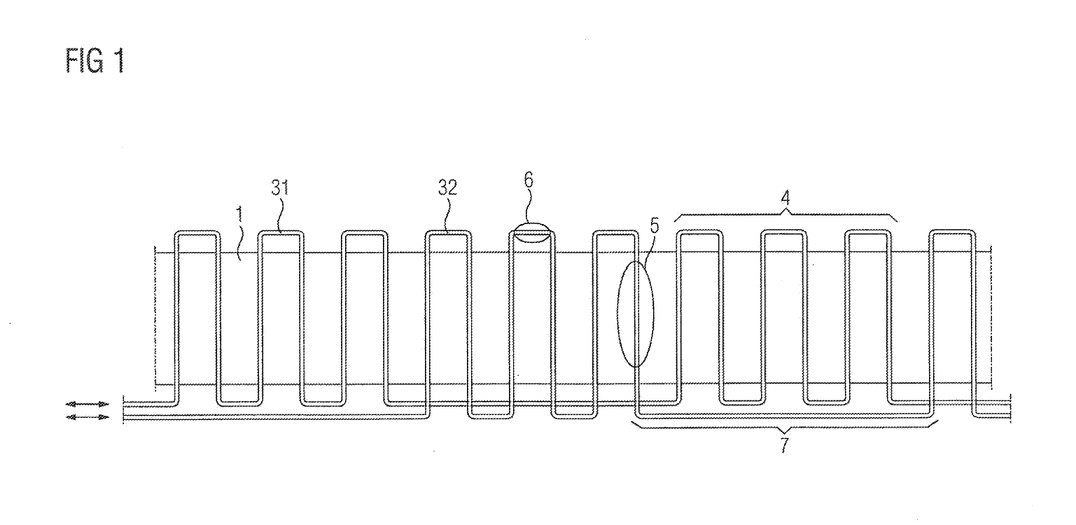

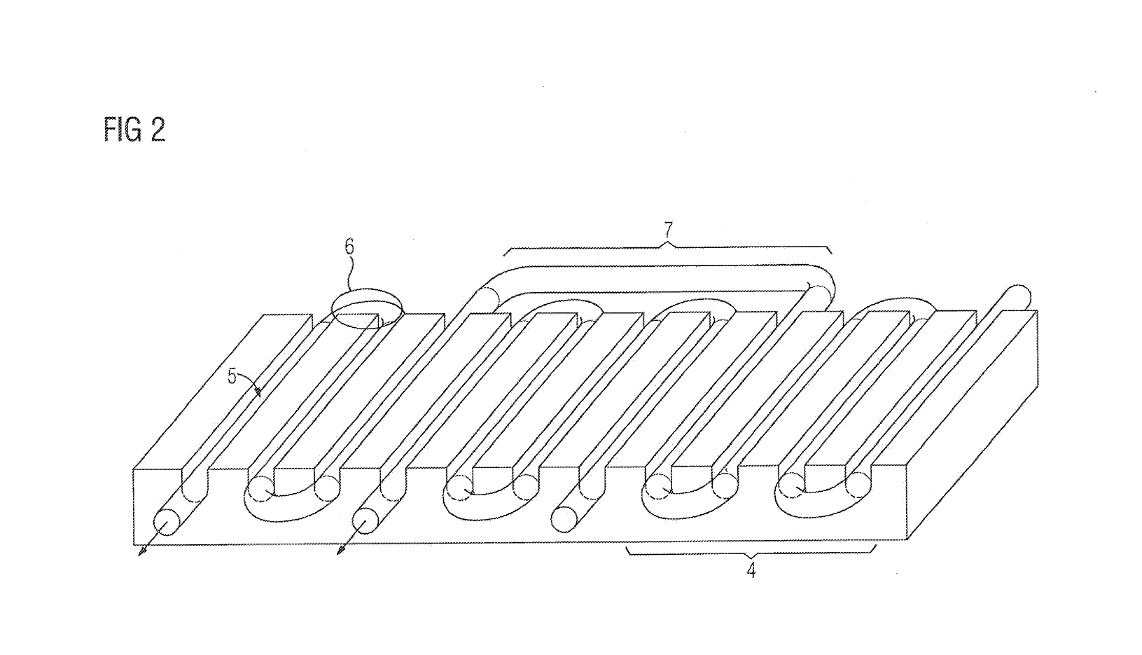

Turning now to the drawing, and in particular to FIG. 1, there is shown a schematic and simplified illustration of a possible course of cooling loops in a component 1 in which cooling coils 31, 32 are held. The cooling coils 31, 32 pass in some areas in a serpentine shape through the component 1. The cooling coils 31, 32 include serpentine-shaped sections 4, as well as distance sections 7. Distance sections 7 are designated here as the sections which are not serpentine-shaped. The serpentine-shaped section 4 of a cooling coil 31, 32 includes cooling pipes 5 and turns 6. The cooling pipes 5 are preferably in direct contact with the component 1. The turns 6 connect the cooling pipes 5 by diversions. The diversions can be designed in a semicircular, oval or angled shape. FIG. 1 only shows the cooling coils 31, 32 on the surface of the component 1 however. Further options are known however for establishing a good thermal contact between the component and the cooling coil, as FIG. 2 also demonstrates. The double-ended arrows close to the ends of the cooling coils are intended to illustrate the possible throughflow directions of the coolant.

FIG. 2 shows an embodiment of the device in which only two cooling coils 31, 32 contribute to cooling the component. In this case, one of the cooling coils 31, 32 has only one serpentine-shaped section 4, which is localized in the central area of the component 1. The other one of the cooling coils 31, 32 possesses two serpentine-shaped sections 4, which are provided for cooling the two outer areas of the component 1. In FIG. 2, the cooling coils 31, 32 are inserted into grooves, so that a form-fit connection between the cooling coils 31, 32 and the component 1 ensures effective cooling. In the case of a laminated core of an electric machine to be cooled, the direction of the cooling pipes 5 is to be selected orthogonal to the laminations, as is indicated by the crosshatching of the component 1, since these grooves can be taken into account during the manufacturing of the laminations, for example by a punch process, without significant additional effort in the manufacturing process.

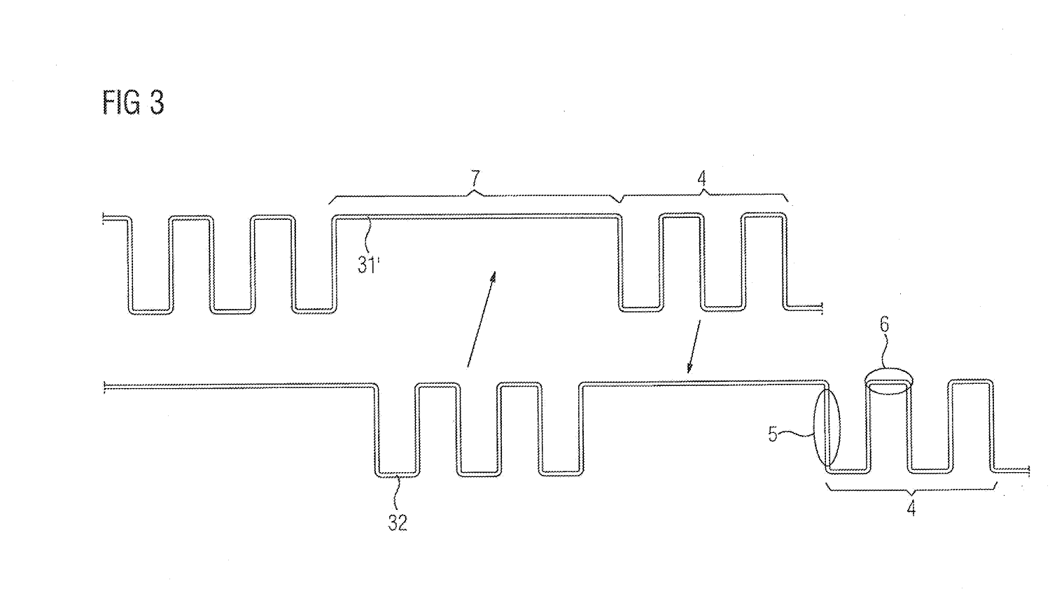

FIG. 3 illustrates the interaction of two cooling coils 31, 32, as can especially be used in a torque motor or a linear motor. This illustration shows a non-limiting example in which both cooling coils 31, 32 have a serpentine-shaped section 4 with six turns 6 and one with five turns 6. Depending on the extent of the component 1 to be cooled as well as the amount of heat arising, one or more of these combinations can be used for cooling the component 1. The surface arrows are intended to illustrate that the serpentine-shaped section 4 of the cooling coil 32 is intended for the area which is not directly cooled by the cooling coil 31 through the distance section 7. Conversely the serpentine-shaped section 4 with five turns 6 of the cooling coil 31 is used for cooling in the area of the component 1 which is bridged by the distance section 7 of the cooling coil 32.

In summary, the invention relates to a device for cooling a component 1, especially a laminated core of a dynamoelectric machine, using a first cooling coil 31 and at least one further cooling coil 32. The cooling coils 31, 32 are equipped here with serpentine-shaped sections 4 which are connected via distance sections 7. These serpentine-shaped sections 4 are used to cool individual, non-neighboring areas of the component 1, wherein the distance sections 7 of the first cooling coil 31 are used to bridge those areas for which the serpentine-shaped section 4 of the further cooling coil 32 are provided for cooling the component. Conversely the distance sections 7 of the further cooling coils 32 are used to bridge the areas for which the serpentine-shaped sections 4 of the first cooling coil 31 are provided for cooling.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A device for cooling a component, comprising first and second cooling coils, said first and second cooling coils having serpentine sections and distance sections connecting neighboring ones of the serpentine sections to each other for cooling individual non-neighboring component areas, each said distance section being configured to bridge a component area which is cooled by a one of the serpentine-shaped sections of the first and second cooling coils.

2. The device of claim 1, wherein the component is a laminated core of a dynamoelectric machine.

3. The device of claim 1, wherein each of the first and second cooling coils has at least two of said serpentine sections interconnected by a one of the distance sections, said distance section of the first cooling coil being configured to bridge a component area which is cooled by the serpentine-shaped sections of the second cooling coil, and said distance section of the second cooling coil being configured to bridge a component area which is cooled by the serpentine-shaped sections of the first cooling coil.

4. The device of claim 1, wherein the first cooling coil has a single serpentine-shaped section configured to cool a component area, said second cooling coil having at least two serpentine-shaped sections configured to cool component areas which are not cooled by the first cooling coil.

5. The device of claim 1, wherein the first and second cooling coils are each made of a piece of pipe.

6. The device of claim 1, wherein coolant flows through the first cooling coil in one direction of flow, and coolant flows through the second cooling coil in a direction of flow which is different than the direction of flow through the first cooling coil.

7. The device of claim 1, wherein neighboring component areas cooled by serpentine-shaped sections of the first and second cooling coils, respectively, overlap.

8. The device of claim 1, wherein each serpentine-shaped section of the first and second cooling coils have parallel cooling pipes defined by a diameter and spaced from one another by a spacing, said diameter and said spacing being variable.

9. The device of claim 1, wherein one of the neighboring serpentine-shaped sections has six turns and, following the distance section, the other one of the neighboring serpentine-shaped section has a maximum of five turns.

10. The device of claim 1, wherein the component is a member selected from the group consisting of a stator and a rotor.

11. The device of claim 10, wherein at least one member selected from the group consisting of the rotor and the stator forms part of a dynamoelectric machine.

12. The device of claim 11, wherein the dynamoelectric machine is constructed in the form of a torque motor or a linear motor.

13. A method for cooling a component, comprising form-fittingly fitting cooling pipes into prefabricated recesses of the component to produce first and second cooling coils having serpentine sections and distance sections connecting neighboring ones of the serpentine sections to each other for cooling individual non-neighboring component areas, each said distance section being configured to bridge a component area which is cooled by a one of the serpentine-shaped sections of the first and second cooling coils.

14. The method of claim 13 for cooling especially a laminated core of a dynamoelectric machine.
